(19) United States
(12) Patent Application Publication
(10) Pub. No.: US 2010/0005395 A1
(43) Pub. Date: Jan. 7, 2010

(54) INFORMATION PROCESSING TERMINAL AND CLIENT SERVER SYSTEM

(76) Inventor: Takahisa SHIRAKAWA, Tokyo (JP)

Correspondence Address: Mr. Jackson Chen, 6535 N. STATE HWY 161, IRVING, TX, 75039, US

(21) Appl. No.: 12/496,157

(22) Filed: Jul. 1, 2009

(30) Foreign Application Priority Data
Jul. 7, 2008 (JP) 2008-176437

(51) Int. Cl. G06F 3/01; G06F 15/16

(52) U.S. Cl. 715/740; 709/203

(57) ABSTRACT

An information processing terminal is capable of switching between a thin client mode in which a screen generated by executing an application program in a remote server is received from the remote server and displayed in a display unit, and a local mode in which a screen generated by executing an operation of the application program is displayed in the display unit. The information processing terminal is configured such that the execution of the application program in the local mode is started from the execution state of the application program at a certain time point in the thin client mode.

### INCORPORATION BY REFERENCE

This application is based upon and claims the benefit of priority from Japanese patent application No. 2008-176437, filed on Jul. 7, 2008, the disclosure of which is incorporated herein in its entirety by reference.

### BACKGROUND OF THE INVENTION

1. Field of the Invention

The present invention relates to an information processing terminal and client server system having a thin client mode in which a screen image that is generated when an application program is executed in a remote server is received from the remote server and displayed in the information processing terminal, and a local mode in which a local application program is executed and displayed in the information processing terminal.

2. Description of Related Art

In ubiquitous society in which information services can be provided by connecting to computer networks in various scenes of daily life, it is possible to continue work that is originally operated in one client terminal (herein after called “client”) by using a different client. In order to resume the work that is interrupted in one place in a different place, it is necessary to transfer the work state from the one place to the different place.

For such transfer of work states, thin client systems in which the work itself is executed in a remote server and only processing of signals input from an input device such as a mouse and a keyboard and display of signals transmitted from the remote server are carried out in a client have been disclosed. For example, Japanese Unexamined Application Publication No. 2007-334686 discloses a client capable of displaying an execution screen of a business application that is executed by a client OS (Operating System) started on the server. According to a client like this, it is possible to connect from one client to a server, execute an application program in the server, and store work data at some midpoint in the server. Then, the user can resume the interrupted work by connecting to the server from a different client and reading the midpoint work data from the server.

To use a client disclosed in Japanese Unexamined Application Publication No. 2007-334686, it is necessary to transfer a large amount of data between the client and the remote server. Therefore, if the network between the client and the remote server, for example, is disconnected, the client cannot receive a screen image of the remote server to be displayed, and therefore cannot continue to execute the application program.

Furthermore, when a sufficient network band is not available for the connection with the remote server for such reasons that other devices connected to the network occupy the most part of the network band or the network band itself is limited, the time lag from the manipulation of an input device to the change in the screen in the client in response to the manipulation becomes considerably larger, and thus impairing usability, in comparison with a case where the application program is executed in the client itself.

Such problems can be solved by transferring the execution state of an application program executed in the remote server to the client and executing the application program in the client.

Accordingly, an exemplary object of the invention is to provide a client capable of continuously switching between a thin client mode in which an execution screen of an application program executed in a remote server is received and displayed in the client, and a local mode in which an application program is executed and displayed in the client.

### SUMMARY

A first information processing terminal according to an exemplary aspect of the invention includes: a display unit capable of displaying a screen that is generated by executing an application program in a remote server and received from the remote server, and a screen that is generated by executing the application program by the information processing terminal itself; and a selection unit that selects a screen to be display in the display unit among a screen received from the remote server and a screen generated by executing the application program by the information processing terminal itself, wherein the information processing terminal starts execution of the application program by itself from an execution state of the application program at a time when the selection unit changes the screen to be displayed from a screen received from the remote server to a screen generated by executing the application program by the information processing terminal itself.

A second information processing terminal according to another exemplary aspect of the invention is capable of switching between a thin client mode in which a screen generated by executing an application program in a remote server is received from the remote server and displayed in a display unit, and a local mode in which a screen generated by executing an operation of the application program is displayed in the display unit, wherein execution of the application program in the local mode is started from an execution state of the application program at a certain time point in the thin client mode.

A first client server system according to another exemplary aspect of the invention includes: a remote server that transmits a screen generated by executing an application program through a network; and an information processing terminal capable of switching between a thin client mode in which a screen generated by the remote server is received from the remote server through the network and displayed in a display unit, and a local mode in which a screen generated by executing the application program is displayed in the display unit, wherein the information processing terminal starts execution of the application program in the local mode from an execution state of the application program at a certain time point in the thin client mode.

A third information processing terminal according to another exemplary aspect of the invention includes: display means for displaying a screen that is generated by executing an application program in a remote server and received from the remote server, and a screen that is generated by executing the application program by the information processing terminal itself; and selection means for selecting a screen to be display in the display means among a screen received from the remote server and a screen generated by executing the application program by the information processing terminal itself, wherein the information processing terminal starts execution of the application program by itself from an execution state of the application program at a time when the selection means changes the screen to be displayed from a screen received from the remote server to a screen generated by executing the application program by the information processing terminal itself.

A fourth information processing terminal according to another exemplary aspect of the invention is capable of switching between a thin client mode in which a screen generated by executing an application program in a remote server is received from the remote server and displayed in display means, and a local mode in which a screen generated by executing an operation of the application program is displayed in the display means, wherein execution of the application program in the local mode is started from an execution state of the application program at a certain time point in the thin client mode.

A second client server system according to another exemplary aspect of the invention includes: a remote server that transmits a screen generated by executing an application program through a network; and an information processing terminal capable of switching between a thin client mode in which a screen generated by the remote server is received from the remote server through the network and displayed in display means, and a local mode in which a screen generated by executing the application program is displayed in the display means, wherein the information processing terminal starts execution of the application program in the local mode from an execution state of the application program at a certain time point in the thin client mode.

In one aspect, the present invention can provide an information processing apparatus capable of storing an execution state of an application program and resuming an application program based on the stored execution state.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 shows a configuration of a client server system containing an information processing terminal in accordance an exemplary embodiment of the present invention; and

FIG. 2 is a figure for illustrating processes for an information processing terminal operating in a thin client mode to switch to a local mode.

### EXEMPLARY EMBODIMENT

### First Exemplary Embodiment

Exemplary best modes for carrying out the present invention are explained hereinafter with reference to the drawings. In these exemplary embodiments of the present invention, an operation image of an application program in an information processing apparatus is stored in nonvolatile storage means, so that a work state at a time of the storing operation can be reproduced, even after the power supply is temporarily turned off, by reading out the stored operation image.

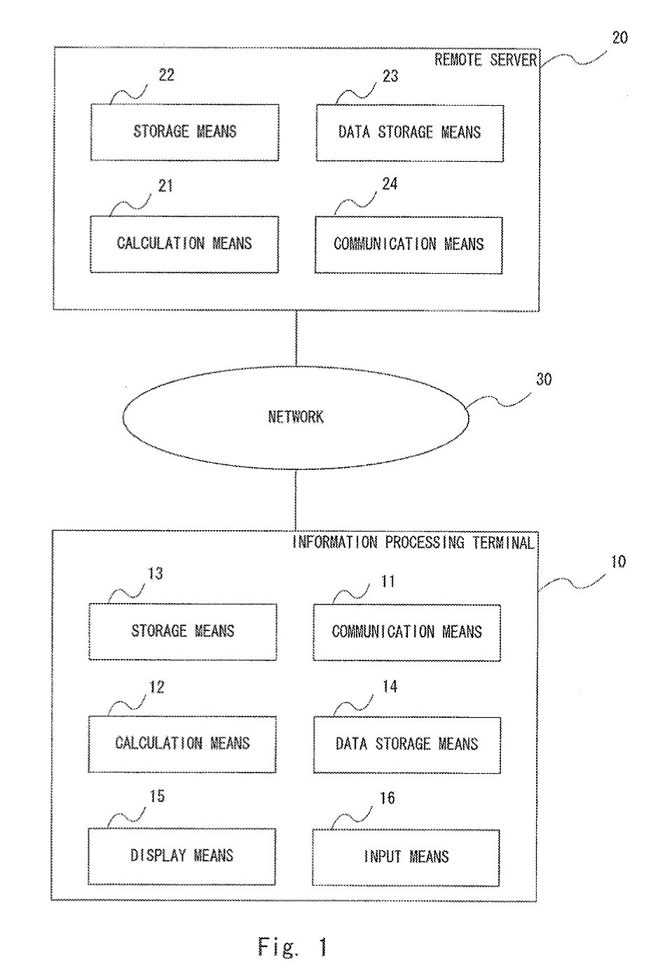

FIG. 1 shows a configuration of a client server system containing an information processing terminal in accordance with this exemplary embodiment of the present invention. Referring to FIG. 1, a client and server system in accordance with this exemplary embodiment of the present invention includes an information processing terminal 10 and a remote server 20 both of which are connected through a network 30, and in which screen information calculated and generated by the remote server 20 can be transferred to and displayed in the information processing terminal 10.

The information processing terminal 10 is configured such that the information processing terminal 10 can switch its operation between a thin client mode in which the information processing terminal 10 transmits input information to the remote server 20, and receives and displays screen information generated by an arithmetic operation(s) in the remote server 20, and a local mode in which the information processing terminal 10 displays screen information generated by an arithmetic operation(s) in the information processing terminal 10 itself. The switching between the thin client mode and the local mode may be performed for the entire screen, or may be performed for each application program that uses a portion of the screen. The information processing terminal 10 includes communication means 11, calculation means 12, storage means 13, data storage means 14, display means 15, and input means 16.

The communication means 11 transmits/receives information to/from the remote server 20 through the network 30. The communication means 11 can be constructed, for example, from a purpose-built integrated circuit such as a network controller, and control software. The calculation means 12 carries out arithmetic processing to generate a screen image in the local mode. The calculation means 12 can be constructed, for example, from a microprocessor.

The storage means 13 temporarily stores an execution code and midpoint data and the like for the arithmetic processing carried out by the calculation means 12 in the local mode. The storage means 13 can be constructed, for example, from a volatile memory such as a dynamic random access memory. The data storage means 14 stores a result of arithmetic processing carried out by the calculation means 12 in the local mode as data. The data storage means 14 can be constructed, for example, from a nonvolatile memory such as a hard disk drive or a flash memory.

The display means 15 selects screen information that is received from the remote server 20 through the network 30 by the communication means 11, or screen information that is generated by arithmetic processing by the calculation means 12, and displays the selected screen information. The display means 15 can be constructed, for example, from purpose-built integrated circuit such as a graphic controller, and control software. The input means 16 generates a signal in response to manipulation by a user, and provides the generated signal for the arithmetic operation. The input means 16 can be constructed, for example, from a keyboard or a pointing device.

The remote server 20 receives a signal generated by the input means 16 of the information processing terminal 10 through the network 30, generates screen information by carrying out arithmetic processing, and transmits the generated screen information to the information processing terminal 10 through the network 30. The remote server 20 includes calculation means 21, storage means 22, data storage means 23, and communication means 24.

The calculation means 21 carries out arithmetic processing to generate a screen image that is to be transmitted to the information processing terminal 10 operating in the thin client mode. The calculation means 21 can be constructed, for example, from a microprocessor. The storage means 22 temporarily stores an execution code and midpoint data and the like for the arithmetic processing carried out by the calculation means 21. The storage means 22 can be constructed, for example, from a volatile memory such as a dynamic random access memory.

The data storage means 23 stores a result of arithmetic processing carried out by the calculation means 21 as data. The data storage means 23 can be constructed, for example, from a nonvolatile memory such as a hard disk drive or a flash memory. The communication means 24 transmits/receives information to/from the information processing terminal 10 through the network 30. The communication means 24 can be constructed, for example, from an integrated circuit such as a network controller, and control software.

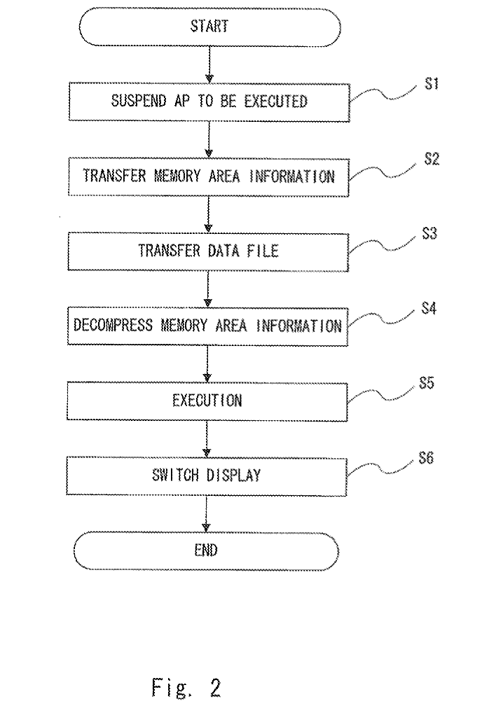

Next, operations of an information processing terminal in accordance with this exemplary embodiment of the present invention are explained hereinafter with reference to FIG. 2. FIG. 2 is a figure for illustrating processes for an information processing terminal 10 operating in a thin client mode to switch to a local mode. When the processes shown in FIG. 2 are started, the information processing terminal 10 is operating in a thin client mode. That is, the information processing terminal 10 is receiving a screen image that is generated by carrying out certain arithmetic processing of an application program (hereinafter called “AP to be executed”) by the calculation means 21 of the remote server 20 through the network 30, and displaying the received screen image in the display means 15.

When the information processing terminal 10 is instructed to switch from a thin client mode to a local mode by a predefined condition such as manipulation made on the input means 16, the information processing terminal 10 first suspends the execution of the AP to be executed in the calculation means 21 of the remote server 20 (step S1). Specifically, this can be implemented, for example, by transmitting a predefined signal from the information processing terminal 10 to the remote server 20 through the network 30 so that the remote server 20 does not assign the calculation means 21 to an arithmetic operation for the AP to be executed.

Next, the information processing terminal 10 causes the remote server 20 to transmit contents stored in an area of the storage means 22 assigned for the AP to be executed through the network 30 (step S2). Then, the information processing terminal 10 causes the remote server 20 to transmit a data file stored in the data storage means 23 through the network 30, and stores the transmitted data file in the data storage means 14 of the information processing terminal 10 (step S3). In this way, data that is being processed for the AP to be executed can be used in a continuous manner without requiring any intervention from a user.

The data file that is transmitted from the remote server 20 in the step S3 may be a data file of an application program other than the application program that is switched from the thin client mode to the local mode, and may be limited to data files having a file format in which they are stored as data by the switched application program. Furthermore, among the data files stored in the data storage means 23, all sorts of data files that are supposed to be transferred may be transmitted, or only the data files that are not stored in the data storage means 14 of the information processing terminal 10 may be transmitted.

Furthermore, when a data file is stored in the data storage means 14 in the step S3, it is also possible to store it such a manner that a path indicating the location of the data file in the file system becomes the same as the path that is used when the data file is stored in the data storage means 23 of the remote server 20. By using such a configuration, data files can be stored and read out without taking into account their paths even after the application program is switched from a thin client mode to a local mode.

Next, the information processing terminal 10 decompresses the contents, which are originally stored in an area of the storage means 22 assigned for the AP to be executed and received from the remote server 20 in the step S2, in the storage means 13 (step S4). Then, the information processing terminal 10 causes the calculation means 12 to perform calculation using the storage contents decompressed in the storage means 13 in the step S4 (step S5). Next, the information processing terminal 10 outputs a screen image generated by the calculation in the step S5 to the display means 15, in place of the screen image received from the remote server 20 through the network 30, and displays the output screen image in the display (step S6).

By carrying out the processes in a manner described above, it is possible to switch the information processing terminal 10 from the a thin client mode in which a screen image generated in the remote server 20 is received and displayed in the information processing terminal 10 to a local mode in which a screen image generated by processing by the calculation means 12 is displayed in the information processing terminal 10 while maintaining the execution state of the AP to be executed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing terminal comprising:
a display unit capable of displaying a screen that is generated by executing an application program in a remote server and received from the remote server, and a screen that is generated by executing the application program by the information processing terminal itself; and
a selection unit that selects a screen to be display in the display unit among a screen received from the remote server and a screen generated by executing the application program by the information processing terminal itself,
wherein the information processing terminal starts execution of the application program by itself from an execution state of the application program at a time when the selection unit changes the screen to be displayed from a screen received from the remote server to a screen generated by executing the application program by the information processing terminal itself.

2. An information processing terminal capable of switching between a thin client mode in which a screen generated by executing an application program in a remote server is received from the remote server and displayed in a display unit, and a local mode in which a screen generated by executing an operation of the application program is displayed in the display unit,
wherein execution of the application program in the local mode is started from an execution state of the application program at a certain time point in the thin client mode.

3. The information processing terminal according to claim 2, wherein the switching between the thin client mode and the local mode can be performed for each application program.

4. The information processing terminal according to claim 2, wherein a file in which execution state of the application program at the time point in the thin client mode is stored is received from the remote server, and execution of the application program in the local mode is started from the execution state of the application program based on the file.

5. The information processing terminal according to claim 1, wherein a data file to store an execution result of the application program is received from the remote server and stored in a data storage unit.

6. The information processing terminal according to claim 5, wherein the data file is stored in the data storage unit in such a manner that a path indicating a location of the data file becomes the same as a path that is used when the data file is stored in the remote server.

7. A client server system comprising:
a remote server that transmits a screen generated by executing an application program through a network; and an information processing terminal capable of switching between a thin client mode in which a screen generated by the remote server is received from the remote server through the network and displayed in a display unit, and a local mode in which a screen generated by executing the application program is displayed in the display unit,
wherein the information processing terminal starts execution of the application program in the local mode from an execution state of the application program at a certain time point in the thin client mode.

8. An information processing terminal comprising:
display means for displaying a screen that is generated by executing an application program in a remote server and received from the remote server, and a screen that is generated by executing the application program by the information processing terminal itself; and
selection means for selecting a screen to be display in the display means among a screen received from the remote server and a screen generated by executing the application program by the information processing terminal itself,
wherein the information processing terminal starts execution of the application program by itself from an execution state of the application program at a time when the selection means changes the screen to be displayed from a screen received from the remote server to a screen generated by executing the application program by the information processing terminal itself.

9. An information processing terminal capable of switching between a thin client mode in which a screen generated by executing an application program in a remote server is received from the remote server and displayed in display means, and a local mode in which a screen generated by executing an operation of the application program is displayed in the display means,
wherein execution of the application program in the local mode is started from an execution state of the application program at a certain time point in the thin client mode.

10. A client server system comprising:
a remote server that transmits a screen generated by executing an application program through a network; and an information processing terminal capable of switching between a thin client mode in which a screen generated by the remote server is received from the remote server through the network and displayed in display means, and a local mode in which a screen generated by executing the application program is displayed in the display means,
wherein the information processing terminal starts execution of the application program in the local mode from an execution state of the application program at a certain time point in the thin client mode.
